(19) United States
(12) Patent Application Publication
(10) Pub. No.: US 2008/0212874 A1
(43) Pub. Date: Sep. 4, 2008

(54) Method for Spectral Integrated Calibration of an Image Sensor by Means of a Monochromatic Light Source

(76) Inventor: Stefan Steib, Munchen (DE)

Correspondence Address: BYIP, LTD., P.O. BOX 1484, GENERAL POST OFFICE, HONG KONG, CN

(21) Appl. No.: 12/089,396

(22) PCT Filed: Oct. 2, 2006
(86) PCT No.: PCT/EP06/09555

§ 371 Date: Apr. 7, 2008

(30) Foreign Application Priority Data
Oct. 7, 2005 (DE) 10 2005 048 240.6

(51) Int. Cl. G06K 9/00

(52) U.S. Cl. 382/162

(57) ABSTRACT

A method of spectral integrated calibration of an image sensor (6) in an image-recording instrument (1). The image sensor (6) is illuminated with a plurality of predetermined light spectra, preferentially by monochromatic light-sources. The method includes the following steps: providing an image-recording instrument (1) having a device, integrated therein, for providing the plurality of predetermined light spectra, and illuminating the image sensor (6) with the plurality of predetermined light spectra of the device. In addition, an image-recording instrument (1) with an image sensor (6), said image-recording instrument (1) including a device that, for the purpose of spectral calibration of the image sensor (6), provides a plurality of predetermined light spectra with which the image sensor (6) is capable of being illuminated.

### BACKGROUND OF THE INVENTION

The invention relates to a method for spectral calibration of an image sensor in an image-recording instrument. More precisely, the invention relates to a method in which the image sensor is illuminated with a plurality of predetermined light spectra. The invention further relates to an image-recording instrument with an image sensor.

### STATE OF THE ART

In digital photography, in video recordings or in the scanning of images, analogue data are generated by photoelectrically sensitive circuits, such as photodiodes for example, said data being subsequently converted into digital values by means of an AD (analogue-digital) converter. For black-and-white recordings, the intensity values are measured over an entire common spectrum. For colour recordings, varying measurement spectra are measured by means of certain measures, for example by means of variably photosensitive circuits. In this connection, each colour corresponds to a measurement spectrum. A colour data record arises out of the measurements of the various measurement spectra. In this connection, in digital photography, in video recordings and also in scanning, the so-called RGB (red-green-blue) process comes into operation. This process describes all the colour values of the sensor being used that are capable of being registered as an addition to the primary colours red, green and blue, by which all the colours located within a predetermined colour gamut—that is to say, colour range—can then be defined.

By reason of differing characteristics of the individual photoelectrically sensitive circuits of differing digital input instruments, and depending on the available illumination, in the case of the RGB process—which is conventional in these instruments—different colour values arise for one and the same object. But it is necessary to obtain genuine colours for further processing. Therefore a calibration of the cameras and scanners is necessary.

Previous processes provide that a calibrating master or a calibrating target is registered by a camera or a scanner, the image that has been formed is compared with reference values, and from this comparison correction values are ascertained with which the colour-corrected image is then created. This may be effected, for example, by means of the known ICC (International Color Consortium) profiles.

The calibrating targets are mostly produced on photographic paper, by printing processes, or by manual application of pigments, and accordingly act subtractively, i.e. by virtue of mixing of pigments on a carrier material. Accordingly, however, the maximum density—that is to say, the colour range, also called the colour gamut—is limited by the pigments that are used, and the maximum brightness is limited by the carrier material. These targets are therefore also called reflective. But if the colour gamut of the master to be recorded, or of the scene, is now greater than the gamut of the target, this target is capable of describing the colours that are used only in some details. Moreover, by virtue of the light-source of the prevailing illumination, the colours of the target are always dependent on the achromatic point and are burdened with metamerism; that is to say, they do not necessarily describe the colour properties of a different material having different pigments but having the same measured colour values in the case of a similar illuminant—that is to say, a similar light-source.

In December 2004 an emissive target—that is to say, a target emitting coloured light—was presented as a development by the company HP, said target being described in “Emissive Chart for Imager Calibration”, Jeffrey M. DiCarlo et al., in Twelfth Color Imaging Conference Color Science and Engineering Systems, Technologies, Applications, Scottsdale, Ariz.; 9 Nov. 2004, pages 295 to 301, ISBN/ISSN: 0-89208-254-2. Said target is intended to be utilised in order to ascertain the spectral behaviour of the image-recording instrument and then to calibrate it spectrally by means of the correction values obtained. Consequently, the intention is to avoid the achromatic point of the illumination that is being used having to be defined for the further processing, this constituting one of the main problems in the case of ICC profiles. The metamerism problem is also to be dispensed with, since only colours of the spectrum having absolute values are measured and then calibrated. In its optical structure the known emissive target resembles the so-called color checker which has been developed by Gretag Macbeth as a reflected-light target.

The known emissive target has the disadvantage, inter alia, that its use is only possible when the illumination surrounding the target is so much darker that the emitted colours of the spectrum are not overexposed or falsified. In addition, a falsification of the colours may occur as a result of changing optics, particularly in the case of digital reflex cameras. Moreover, specular reflections or scattered-light effects on the target surface may falsify the result of measurement. In addition, it may be problematic that the emitting light-sources generate different colour values in the event of fluctuations in voltage. The achievement and measurement of secondary colours and shades of grey generally requires extremely precise and expensive spectral measuring instruments. It is also to be feared that the known target has to be constantly examined in respect of its colour content in operation, a procedure which—unlike in laboratory applications—is not really practicable in everyday use. Furthermore, there is a risk of the known target being contaminated, mechanically worn or damaged by handling.

### PROBLEM UNDERLYING THE INVENTION

The object underlying the invention is to provide an improved method for spectral calibration of an image sensor in an image-recording instrument. The object underlying the invention is, in addition, to provide an improved image-recording instrument having an image sensor. In particular, the object underlying the invention is to overcome one or more disadvantages of the aforementioned state of the art.

### SOLUTION ACCORDING TO THE INVENTION

The object is achieved by means of a method for spectral calibration of an image sensor in an image-recording instrument, said process having the features of claim 1. In this connection, the idea underlying the invention is to preserve the advantages of the known spectral calibration but to separate them from their disadvantages. By virtue of the fact that the device for providing the predetermined light spectra is integrated within the image-recording instrument, it is an attainable advantage of the invention that the calibration is less strongly influenced, or remains substantially unaffected, by external influences, in particular scattered light, reflections, excessive ambient brightness, lens aberrations and/or fluctuations in voltage.

The object is achieved, in addition, by means of the image-recording instrument with an image sensor, according to claim 6. By virtue of the fact that the image-recording instrument itself includes the device for spectral calibration of the image sensor, it is an attainable advantage of the invention to shield the calibration better from external influences, in particular scattered light, reflections, excessive ambient brightness, lens aberrations and/or fluctuations in voltage. With the invention, it can be ensured that a calibration with an external reflective or emissive target becomes superfluous. The invention is particularly suitable for portable image-recording instruments such as, for example, portable still cameras and video cameras.

### STRUCTURE AND FURTHER DEVELOPMENT OF THE SOLUTION ACCORDING TO THE INVENTION

In a preferred embodiment of the method according to the invention, the measured values of the image sensor illuminated with the predetermined light spectra are read out, where appropriate stored in the form of an image, and compared with predetermined set values, and subsequently correction values are ascertained on the basis of the comparison between measured values and set values. In particularly preferred manner the correction values together constitute one or more correction tables. It is an attainable advantage of the invention that with these correction values consecutive images can be linearised and/or calibrated independently of external light influences, errors due to the optical system, or other fluctuations.

Since the calibrating preferentially lasts only until such time as an exposure is carried out and the correction values are read out, it can be ensured that this is effected in a matter of seconds and fully automatically, but also upon user request. In a first embodiment of the invention, the image-recording instrument is adjusted in such a way that for the purpose of achieving extremely high quality a calibration is carried out repeatedly at regular time-intervals or after a fixed number of images. In a second embodiment, the calibration is always carried out after the image-recording instrument has been switched on. In a third embodiment, the calibration is carried out before each new recording or series of recordings. It is also conceivable to combine the three stated embodiments.

In one embodiment of the invention, the calculations that are necessary for calibration are executed in the image-recording instrument by means of software. In another embodiment, the calculations are carried out in an external computer. It is also conceivable to execute one part of the calibration within the image-recording instrument, and another part outside the image-recording instrument. It is an attainable advantage of the two last-named embodiments that the calibration can also be executed if the computing capacity of the computer that is being used in the image-recording instrument is not sufficient for this, for example if very large image files are generated in the case of professional camera-backs.

In one embodiment of the invention, the correction values are appended to the data record of the image. In this embodiment, the raw data are preferentially not changed. In a first particularly preferred embodiment, the correction values are treated like ICC profiles. In a second particularly preferred embodiment, the correction values obtained are added to raw data—the so-called raw data records—of an image recorded with the image-recording instrument, in particularly preferred manner in the form of an EXIF tag. In a third particularly preferred embodiment, the correction values are appended to a data record of the image in the form of XML (eXtended Markup Language) data. Alternatively, the correction data may also be integrated in manufacturer-specific manner into the respective raw data record. In another embodiment of the invention, the correction values are applied to an image that was recorded with the image-recording instrument, in order to transform it into a predetermined working colour space. Particularly preferentially, the transformed image is subsequently output by the image-recording instrument, preferentially in the TIF or JPG format. It is also conceivable to combine the stated processes with one another.

It is an attainable advantage of the invention that, for the purpose of achieving an optimal colour accuracy by calibrating, no targets of any kind have to be used any longer in the working procedure in the course of photographing. In particularly preferential manner the calibration takes place fully automatically. It is an attainable advantage of the invention that the user does not notice the calibration and/or the application thereof in the course of normal use of the image-recording instrument.

In a preferred embodiment of the invention, the achromatic point of the scene being photographed is established by fully automated means with one of the processes that are known for this purpose or that will become known in future. The colour information, for example in the form of raw data, is preferentially available at each processing stage. It is an attainable advantage of this embodiment of the invention that the achromatic point can still be changed retrospectively.

In a preferred embodiment, the invention is compatible with the model of the Windows Color System (WCS) that Microsoft has presented as a component of the future Windows “VISTA” computer operating system and that is concerned with fully automatic workflows for the purpose of achieving excellent colour accuracy without user control. The WCS provides that sensor-specific information is introduced into the workflow to an increased extent and is utilised for the purpose of automation in the course of further processing. With this embodiment of the invention, an extensive automation and high colour accuracy in the environment of the Windows operating system can be attained.

In a preferred embodiment of the image-recording instrument according to the invention, the image sensor includes photoelectrically sensitive circuits, for example photodiodes. A particularly preferred image sensor is a two-dimensional CCD field or a CCD line. The preferred image sensor includes an AD converter, in order to convert analogue measured values of the photosensitive circuits into digital values.

The spectra are preferentially substantially monochromatic in each instance. The device preferentially provides three light spectra. In particularly preferential manner the spectra correspond to the primary colours red, green and blue.

It is an attainable advantage of the invention that a purely spectral calibration and linearisation can be performed. The spectra are preferentially projected directly onto the image sensor. In a preferred embodiment of the invention, the device is arranged relative to the image sensor in such a way that the plurality of light spectra partially overlap each other when impinging on the image sensor, and mix in the overlapping regions. In particularly preferential manner the three spectra—red, green and blue—which are each substantially monochromatic overlap each other. Generating arbitrary colour gradations in the desired intensity can be ensured in this way. In particular, the secondary colours yellow, cyan and magenta, all possible intermediate values, and white, can be generated with the invention. In a preferred embodiment, the spectra overlap each other in such a manner that colour scales and the uniformity thereof can also be represented and examined. It is an attainable advantage of the invention that, by means of predetermined action as well as selection of the spectral region of the monochromatic light-sources, the generated colour gamut of these colours of the spectrum can be far greater than the colour gamut of the reading sensor.

The light spectra are preferentially not generated by reflection. A preferred device for spectral calibration of the image sensor includes a plurality of light-sources, each of which generates a light spectrum. Substantially monochromatic emitters in the primary colours red, green and blue preferentially come into operation by way of light-source. Preferred emitters are light-emitting diodes (LEDs), diode lasers or miniature lasers, in particular tunable lasers, as well as all light-sources that will be suitable in future. If the image sensor is a two-dimensional sensor array, the device preferentially includes at least three light-sources. In the case of a one-dimensional sensor line, the device preferentially includes at least five light-sources.

In a preferred embodiment, the device includes—in addition to the substantially monochromatic red, green and blue light-sources—a light-source that generates a substantially white light spectrum, preferentially a white broadband LED. By this means, in particular a maximal brightness value can be made available for the purpose of calibrating.

In a preferred embodiment of the invention, the light is projected from the device onto the sensor by means of lenses and/or mirrors. Use may be made, for example, of microlenses and/or micromirrors such as are known from DLP (Digital Light Processing) technology. In another embodiment of the invention, a laser with image control comes into operation.

The device according to the invention for spectral calibration of the image sensor is preferentially arranged behind the objective, in each instance immediately in front of the image sensor. In one embodiment of the invention, the image-recording instrument is a digital still camera or a video camera, particularly preferably a reflex camera. Here the colour-source is preferentially arranged within the mirror case. The respective arrangement and number of the light-sources is also dependent on the positioning of the automatic-focusing system which, in many cameras, operates with a secondary mirror fastened below the primary mirror. A projection from several angles is also conceivable.

In another embodiment of the invention, the image-recording instrument is a scanner which scans a master, line by line. The image sensor includes a sensor line which resolves the image along its longitudinal axis (main scan direction). The sensor line is preferentially moved in the sub-scan direction by means of a stepping motor, in order in this way to scan the image, line by line. Five or more light-sources, particularly preferentially light-emitting diodes, are mounted below the sensor line in such a way that a spectral calibration is performed instead of, or in addition to, the white balance which is conventional in scanners anyway. In a preferred embodiment of the invention, the light-emitting diodes are arranged in the housing; in another preferred embodiment, they are arranged in the master cover of the scanner.

It is an attainable advantage of the invention that the additional costs of the incorporation of a device according to the invention for spectral calibration into a high-quality digital still camera, a video camera or a scanner amount to only a few euros, even with initially low piece-numbers. In addition, it can be ensured that, in the event of mass production, such emitter units are prefabricated and produced for a few euro cents.

The devices are preferentially produced and precalibrated with high precision in the form of complete emitter units, in each instance specially adapted to the given conditions of the image-recording instrument, such as sensor size, sensor type or desired quality-level. Since exact standards and measuring regulations of the CIE and of the ISO already exist for the utilisation of the LEDs, it is an attainable advantage of the invention that the calibration can be carried out in accordance with already existing measuring-instrument specifications. Furthermore, a practically unlimited life of these emitter units can be obtained, because, for example, LEDs are able to function in uniformly trouble-free manner for between 60,000 and 100,000 hours in the case of permanent light.

It is an attainable advantage of the invention that the manufacturing costs of digital still cameras, video cameras and scanners are lowered, since, as a result of the individual calibration of the image sensors that are used, use may also be made of sensors that normally lie outside certain quality specifications. It is therefore conceivable that a final inspection in this regard becomes unnecessary, and the camera or the scanner adjusts itself to optimal quality values as soon as the calibration sensor is in operation.

### BRIEF DESCRIPTION OF THE DRAWINGS

The invention will be elucidated in greater detail in the following on the basis of schematic drawings of a number of exemplary embodiments.

Shown are:

FIGS. 1a and 1b: a front view of first and second exemplary embodiments of an image-recording instrument according to the invention,

FIG. 2: a side view of a third exemplary embodiment of an image-recording instrument according to the invention,

FIG. 3: a front view of a fourth exemplary embodiment of an image-recording instrument according to the invention,

FIG. 4: a perspective view of a fifth exemplary embodiment of an image-recording instrument according to the invention,

FIG. 5: a first exemplary selection of measuring fields in the case of a two-dimensional image sensor with central projection of the light spectra onto the sensor,

FIG. 6: a second exemplary selection of measuring fields in the case of a two-dimensional image sensor with lateral projection of the light spectra onto the sensor, and

FIG. 7: an exemplary selection of measuring points in the case of a sensor line.

### DETAILED DESCRIPTION OF AN EXEMPLARY EMBODIMENT

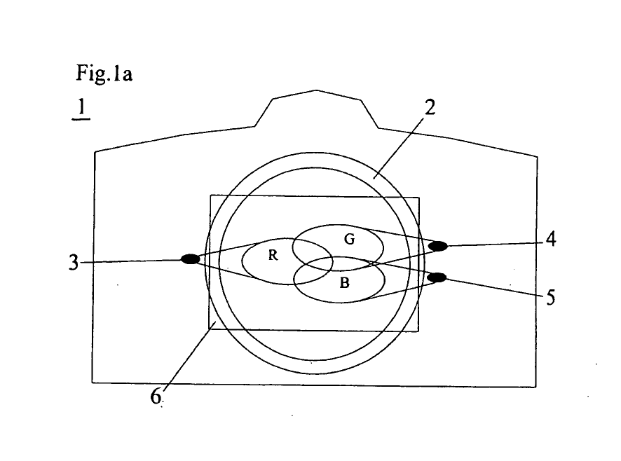

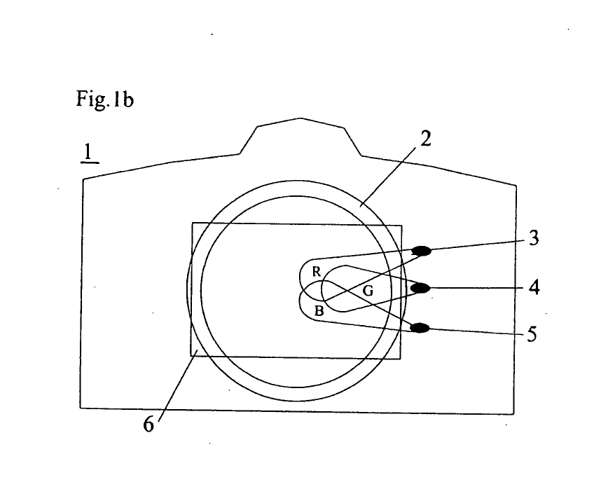

The exemplary embodiments represented in FIGS. 1a and 1b of an image-recording instrument 1 according to the invention are constituted by a reflex camera with a camera housing and with an objective mount 2. The red, green and blue LEDs 3, 4 and 5 arranged in the camera housing by way of light-sources project their light laterally directly onto the image sensor 6 on both sides, from the right and from the left, or on one side only, from the right. By reason of the lateral projection, the circular symmetrical light cones generate substantially egg-shaped colour areas R, G and B on the surface of the image sensor 6. In addition, the light cones of the individual light-sources 3, 4 and 5 partially overlap and form secondary colours on the image sensor 6 in some regions.

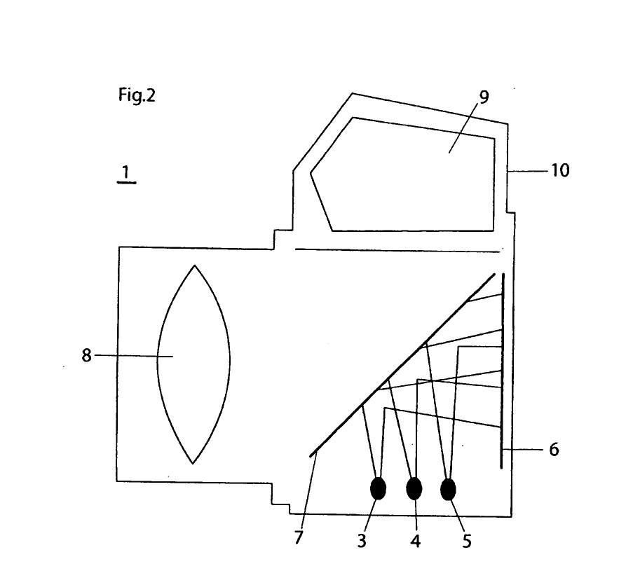

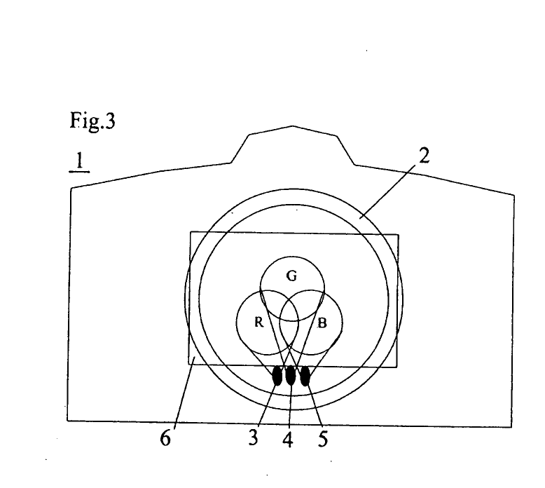

The exemplary embodiment represented in FIG. 2 also shows a reflex camera. The camera is equipped, as usual, with a rapid-return mirror 7 which conducts light that is incident through a lens system 8 of the objective to a pentaprism 9, from where it reaches the viewfinder 10. In the embodiment shown in FIG. 2, the LEDs 3, 4 and 5 project their light perpendicularly and centrally onto the image sensor 6 from below via the rear of the rapid-return mirror 7, which for this purpose is likewise silvered. The patches of light are therefore circular. Once again, secondary colours arise in overlapping regions of the light cones. In the exemplary embodiment represented in FIG. 3, the LEDs 3, 4 and 5 project their light in the colours red, green and blue almost perpendicularly onto the image sensor 6 from obliquely below the rapid-return mirror 7. The patches of light R, G and B are therefore almost circular to the same degree.

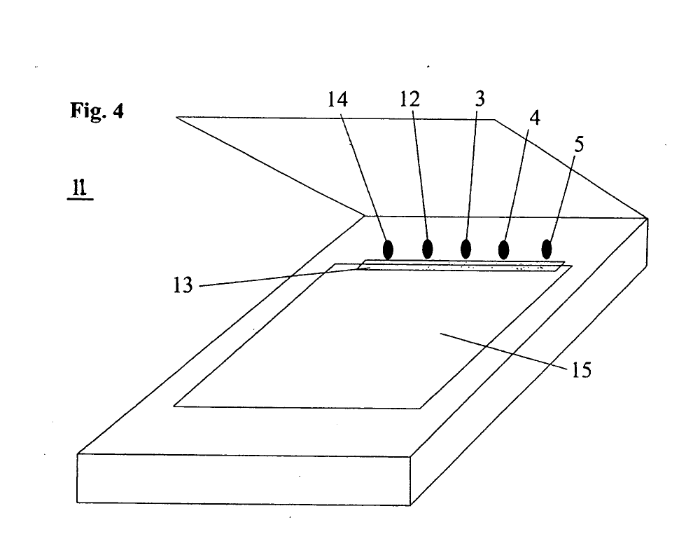

The exemplary embodiment shown in FIG. 4 shows a reflected-light scanner 11 in which five LEDs, in the colours red 3, green 4, blue 5 and—once again—blue 12, are mounted opposite the sensor line 13. In addition, a white LED 14 is provided. The arrangement is located in the housing of the scanner, above the master glass 15, at the point where, in ordinary scanners, a device for a white balance is frequently located.

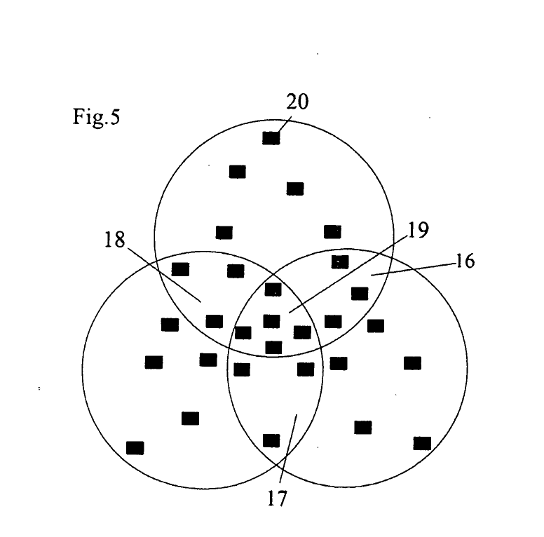

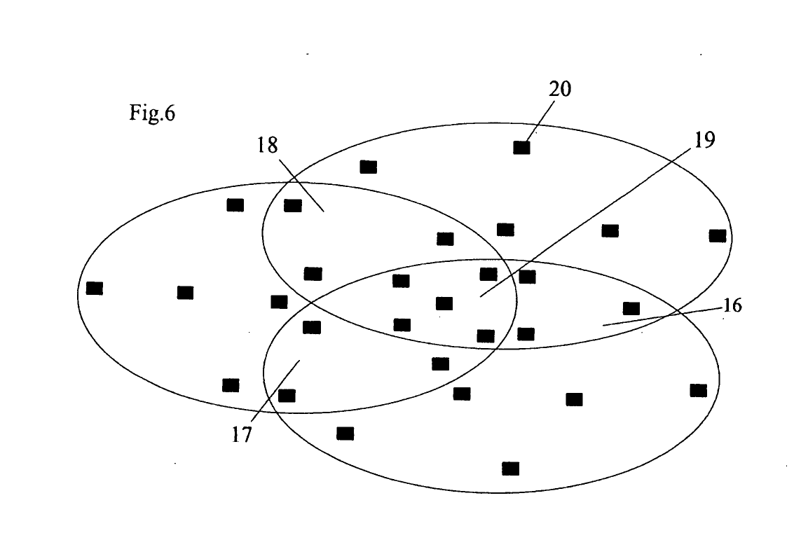

As can be seen in FIGS. 5 and 6, the light cones of the individual LEDs 3, 4 and 5 overlap in the exemplary embodiments shown in FIGS. 1 to 3, though the edges of the cones are not sharp, but instead the respective light intensity falls to substantially zero in a transition region. As a result, in the overlapping regions 16, 17, 18 and 19 continuously extending gradations of secondary colours are formed, including the colours cyan in overlapping region 16, magenta in overlapping region 17, yellow in overlapping region 18, and white in overlapping region 19. Some of these secondary colours are selected for the calibration by means of predetermined measuring fields, one of which—representative of all of them—is denoted by reference symbol 20.

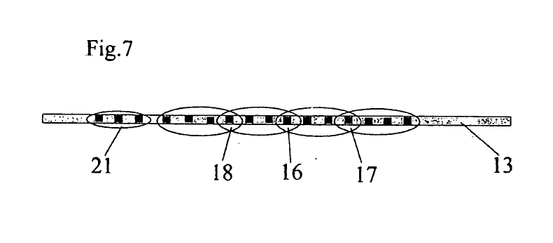

FIG. 7 shows how the colour cones of the LEDs 3, 4, 5 and 14 overlap also in the exemplary embodiment of the reflected-light scanner shown in FIG. 4. Once again, continuously extending gradations of secondary colours arise in the overlapping regions, including the colours cyan in overlapping region 16, magenta in overlapping region 17 and yellow in overlapping region 18. Moreover, the white LED generates a white patch of light. For the purpose of calibration, certain secondary colours are selected by predetermined measuring points, one of which—once again, representative of all of them—is denoted by reference symbol 21.

1-15. (canceled)

16. A method of spectral calibration of an image sensor in an image-recording instrument, the image sensor being illuminated with a plurality of predetermined light spectra, the method comprising:
providing an image-recording instrument comprising a device integrated therein for the purpose of providing the plurality of predetermined light spectra, and
illuminating the image sensor with the plurality of predetermined light spectra of the device.

17. The method according to claim 16, further comprising:
reading out measured values of the image sensor illuminated with the predetermined light spectra,
comparing the measured values with predetermined set values, and
ascertaining correction values on the basis of the comparison between measured values and set values.

18. The method according to claim 16, further comprising adding the correction values to raw data of an image recorded with the image-recording instrument.

19. The method according to claim 16, further comprising:
applying the correction values to an image recorded with the image-recording instrument, in order to transform it into a working colour space, and
outputting the image.

20. The method according to claim 16, further comprising establishing an achromatic point.

21. The method of claim 16, wherein the image-recording instrument is a still camera or a video camera.

22. An image-recording instrument with an image sensor, the image-recording instrument comprising a device, for the purpose of spectral calibration of the image sensor, providing a plurality of predetermined light spectra with which the image sensor is capable of being illuminated.

23. The image-recording instrument according to claim 22, wherein the device provides at least three substantially monochromatic light spectra that correspond to the primary colours red, green and blue.

24. The image-recording instrument according to claim 22, wherein the device is arranged relative to the image sensor in such a way that the plurality of light spectra overlap each other at least partially when impinging on the image sensor, and mix in the overlapping regions.

25. The image-recording instrument according to claim 22, wherein the device comprises a plurality of light-sources, each of which generates a light spectrum pertaining to the plurality of light spectra.

26. The image-recording instrument according to claim 25, wherein the device comprises a light-source which generates a substantially white light spectrum.

27. The image-recording instrument according to claim 22, wherein the light is projected from the device onto the sensor by at least one lens and/or at least one mirror.

28. The image-recording instrument according to claim 22, wherein the device is arranged within a housing of the image-recording instrument.

29. The image-recording instrument according to claim 22, wherein the image-recording instrument is a still camera or a video camera.

30. The image-recording instrument according to claim 22, wherein the image-recording instrument is a reflex camera with a mirror case, and the device is arranged within the mirror case.

31. The image-recording instrument according to claim 22, wherein the recording instrument is a scanner which scans a master, line by line.
